(19) United States
(12) Patent Application Publication
(10) Pub. No.: US 2008/0263532 A1
(43) Pub. Date: Oct. 23, 2008

(54) Data updating method and electric device using the same

(75) Inventors: Tsung-Cheng Yang, Taipei (TW); Chao-Hui Shen, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/081,874

(22) Filed: Apr. 23, 2008

(30) Foreign Application Priority Data
Apr. 23, 2007 (TW) 96114317

(51) Int. Cl. G06F 9/44

(52) U.S. Cl. 717/168

(57) ABSTRACT

A data updating method and an electric device using the same are provided. The data updating method is for updating a first software file set of a mobile device adapted to be electrically connected to the electric device. The electric device has an updating program code for performing the data updating method. The method includes following steps. The first software file set is transmitted to the electric device from the mobile device and shown in a first window in a step (d). The first software file set is compiled into a second software file set in a step (e). The second software file set is transmitted to the mobile device, and the first software file set is replaced by the second software file set.

This application claims the benefit of Taiwan application Serial No. 96114317, filed Apr. 23, 2007, the subject matter of which is incorporated herein by reference.

### BACKGROUND OF THE INVENTION

1. Field of the Invention

The invention relates in general to a data updating method and an electric device using the same, and more particularly to a data updating method of a mobile device and an electric device using the same.

2. Description of the Related Art

To satisfy the demand for portability, a lot of kinds of mobile devices, such as mobile phones, personal digital assistants (PDA) and global positioning system receivers (GPS receiver), emerge into the market. People can carry such mobile devices with them to communicate with others or handle tasks everywhere.

FIG. 1 is a function block diagram of a conventional mobile device 900. Please referring to FIG. 1, the mobile device 900 includes a memory 910, a capturing unit 940 and a processing unit 950. The general mobile device 900 has lots of installation software including instant messaging installation software, internet phone installation software, finance management installation software or live navigation installation software. The installation software is burned in the memory 910 by manufacturer. When a user boots the mobile device 900 for the first time, the capturing unit 940 automatically captures the software from the memory 910 and processes the installation.

In other words, the software is fixed in the mobile device 900 after manufactured. When a user or a retailer (not the manufacturer) wants to change the software version or add/delete the software in the mobile device 900, the mobile device has to be sent back to the manufacturer to update the software. The data updating method has no flexibility and is very inefficient for the present market full of variety.

Therefore, it is very important to provide a data updating method so that the users or the retailers can update the data themselves.

### SUMMARY OF THE INVENTION

The invention is directed to a data updating method and an electric device using the same. After selected in the electric device, an updating interface is transmitted to a mobile device. Therefore, the data updating method and the electric device using the same have following advantages. There are many choices of the software. The content of the software can be pre-viewed in the updating interface of the electric device. The updating interface is a graphic user interface (GUI) so that the user can operate easily. The user can install or download files to the personal computer through the updating interface conveniently. The data updating process is very safe. The user can update data without sending the mobile device back to the manufacturer.

According to a first aspect of the present invention, a data updating method for updating a software file set of a mobile device is provided. The mobile device is adapted to be electrically connected to an electric device with an updating program code. The updating program code is for performing the data updating method. The data updating method includes following steps. A first software file set is transmitted to the electric device from the mobile device and shown in a first window in a step (d). The first software file set is compiled into a second software file set in a step (e). The second software file set is transmitted to the mobile device, and the first software file set is replaced by the second software file set in a step (g).

According to a second aspect of the present invention, an electric device for storing an updating program code is provided for performing a data updating method. The data updating method is for updating a first software file set of a mobile device. The mobile device is adapted to be electrically connected to the electric device. The data updating method includes following steps. A first software file set is transmitted to the electric device from the mobile device and shown in a first window in a step (d). The first software file set is compiled into a second software file set in a step (e). the second software file set is transmitted to the mobile device, and the first software file set is replaced by the second software file set.

According to a third aspect of the present invention, an electric device with an updating program code is provided for updating a first software file set of a mobile device. The electric device at least includes a second transmission unit, a second display unit and a processing unit. The second transmission unit is for connecting the mobile device and transmitting the first software file set to the electric device. The second display unit is for displaying the first software file set in a first window. The processing unit compiles the first software file set into a second software file set and transmits the second software file set to the mobile device through the second transmission unit. The first software file set is replaced by the second software file set.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a function block diagram of a conventional mobile device;

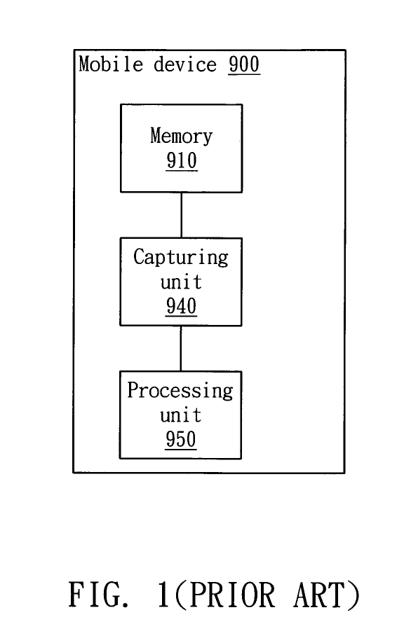

FIG. 2 is a flow chart of a data updating method according to a first embodiment of the present invention;

FIG. 3 is the function block diagram of a mobile device and an electric device according to a first embodiment of the present invention;

FIG. 4 is the function block diagram of the updated mobile device and the electric device in FIG. 3;

FIG. 5 illustrates an updating interface according to the first embodiment of the present invention;

FIG. 6 illustrates the updating interface of the first software file set in FIG. 5 being compiled into a second software file set;

FIG. 7 is a flow chart of the data updating method according to a second embodiment of the present invention;

FIG. 8 is a function block diagram of the mobile device and the electric device of the second embodiment of the present invention;

FIG. 9 is a function block diagram of the mobile device and the electric device after the data is updated;

FIG. 10 illustrates the updating interface of the second embodiment of the present invention;

FIG. 11 illustrates the updating interface of the first software file set and a first auto-configuration file set being compiled into the second software file set and a second auto-configuration file set;

FIG. 12 is a flow chart of the data updating method according to a third embodiment of the present invention;

FIG. 13 is a function block diagram of the mobile device and the electric device according to the third embodiment of the present invention;;

FIG. 14 is a function block diagram of the mobile device and the electric device in FIG. 13 after the data is updated;

FIG. 15 is a flow chart of the data updating method according to a fourth embodiment of the present invention;

FIG. 16 is a function block diagram of the mobile device and the electric device according to the fourth embodiment of the present invention;

FIG. 17 is a function block diagram of the mobile device and the electric device in FIG. 16 after the data is updated; and

FIG. 18 illustrates the updating interface according to the fourth embodiment of the present invention.

### DETAILED DESCRIPTION OF THE INVENTION

### First Embodiment

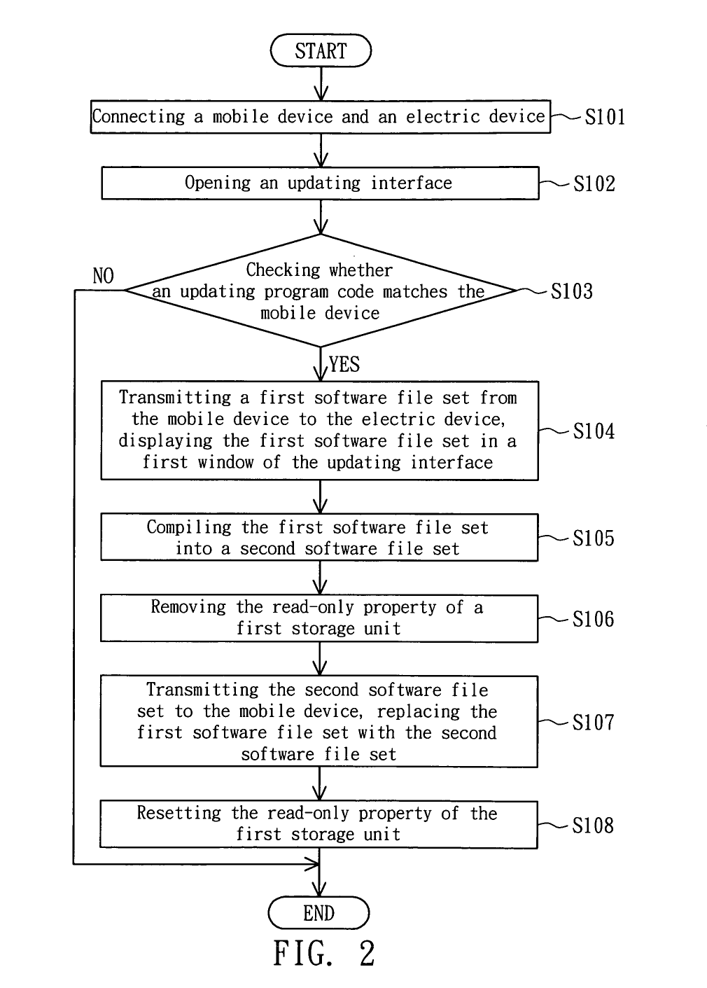

FIG. 2 is a flow chart of a data updating method according to a first embodiment of the present invention. Please referring to FIG. 2, the data updating method is for updating a first software file set SFS1 of a mobile device 100. For illustrating the data updating method of the present embodiment clearly, please refer to both the flow chart and the function block diagram.

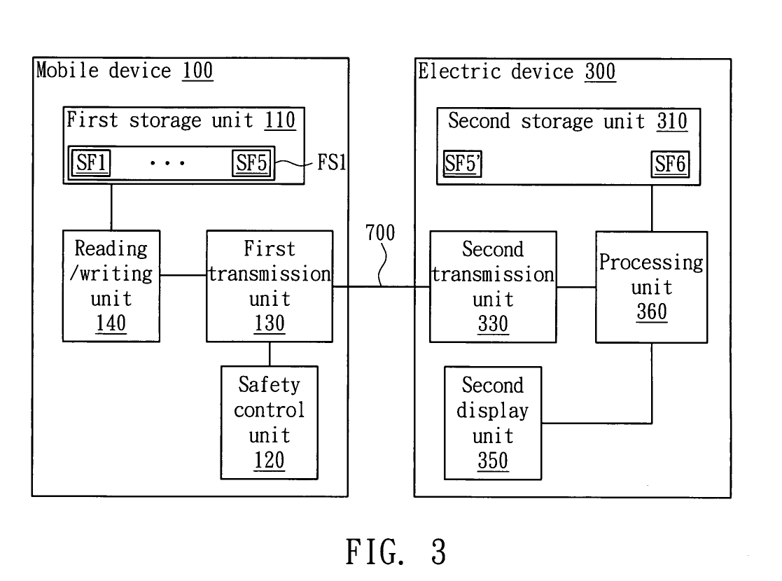

Please refer to FIGS. 2˜3. FIG. 3 is the function block diagram of the mobile device 100 and an electric device 300 according to the first embodiment of the present invention. Although the mobile device 100 and the electric device 300 in FIG. 3 are illustrated as examples in the present embodiment, anyone who has ordinary skill in the field of the present invention can understand that the data updating method of the present invention is not limited thereto.

Also, steps in FIG. 2 are used for illustrating the data updating method of the present invention. However, anyone who has ordinary skill in the field of the present invention can understand that the data updating method of the present invention is not limited thereto. The order of the steps is not limited thereto. Substantially, the step S104, the step S105 and the step S107 can achieve the effect of the data updating method of the present invention.

For example, the mobile device 100 is a mobile phone, a personal digital assistant (PDA) or a global positioning system receiver (GPS receiver). The electric device 300 is a desktop computer or a notebook for example. The mobile device 100 includes a first storage unit 110, a reading/writing unit 140, a first transmission unit 130 and a safety control unit 120. The electric device 300 includes a second storage unit 310, a processing unit 360, a second transmission unit 330 and a second display unit 350. The processing unit 360 is a central processing unit (CPU) for example. The second storage unit 310 is a hard drive for example. The electric device 300 stores an updating program code for performing the data updating method of the present embodiment.

First, in a step S101, the mobile device 100 and the electric device 300 are connected through the first transmission unit 130 and a second transmission unit 330. The mobile device 100 and the electric device 300 communicate through a common communication protocol. For example, the common communication protocol is a universal serial bus (USB), a mini universal serial bus (mini USB) or a high-speed serial bus (IEEE 1394). In other words, the first transmission unit 130 and the second transmission unit 330 are USB ports, mini USB ports or IEEE 1394 ports correspondingly. No matter which ports the first transmission unit 130 and the second transmission unit 330 are, the mobile device 100 and the electric device 300 can be connected through a proper transmission line 700.

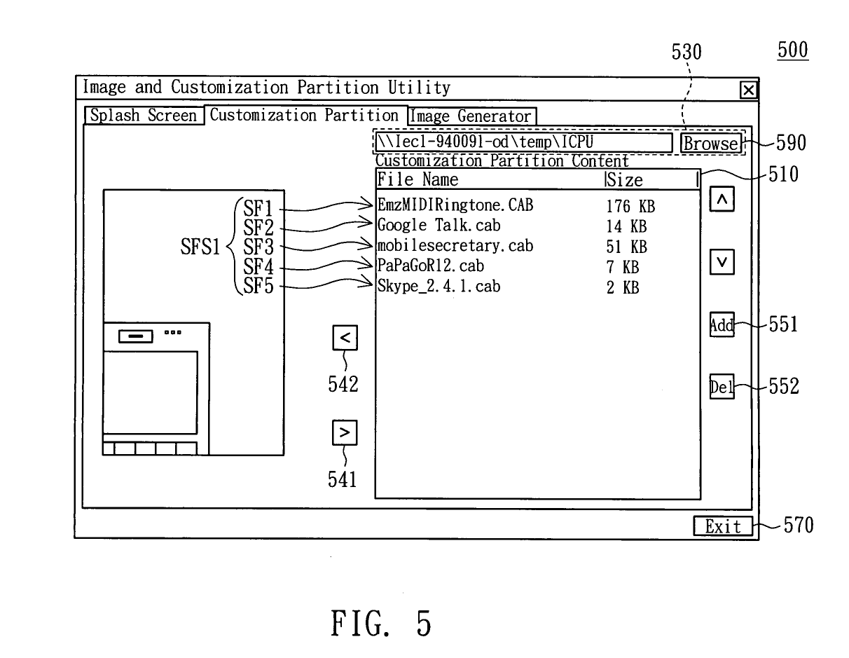

Please refer to both FIG. 3 and FIG. 5. FIG. 5 illustrates an updating interface 500 of the first embodiment of the present invention. In a step S102, the updating interface 500 is launched. The updating interface 500 is shown on the second display unit 350. The second display unit 350 is a liquid crystal display (LCD) or a cathode ray tube display (CRT display) for example. The user can obtain all kinds of information and process operation through the updating interface 500. The updating interface 500 includes a first window 510, a download button 541, a transmission button 542, a folder browse window 530, an “open folder” button 590, a “add file” button 551, a “delete file” button 552 and an exit button 570.

Then, in a step S103, it is checked whether the updating program code and the mobile device 100 match. In the present embodiment, the safety control unit 120 of the mobile device 100 checks whether the updating program code and the mobile device 100 match. For example, the safety control unit 120 checks the version of the operating system, the model number or the international mobile equipment identity (IMEI) of the mobile device 100. Furthermore, it can be checked whether the updating program code and the mobile device 100 match through the processing unit 360 of the electric device 300 in the step S103.

When the updating program code matches the mobile device 100, the method goes to a step S104. When the updating program code does not match the mobile device 100, the method ends.

In the step S104, when the download button 541 of the updating interface 500 is pressed, the first software file set SFS1 is captured by the reading/writing unit 140 of the mobile device 100 from the first storage unit 110 and then transmitted to the electric device 300 through the first transmission unit 130. When the “open folder” button 590 of the updating interface 500 is pressed before download is processed, a folder can be selected. Also, the location of the folder is shown in the folder browse window 530. After the second transmission unit 330 receives the first software file set SFS1, the first software file set SFS1 is stored in the selected folder. The first software file set SFS1 is shown in the first window 510. As shown in FIG. 3 and FIG. 5, the first software file set SFS1 includes five software installation files including a music ring installation file (EmzMIDIRingtone.CAB) SF1, an instant messaging software installation file (GoogleTalk.cab) SF2, a mobile secretary software installation file (mobilesecretarycab) SF3, a navigator software installation file version 12 (PaPaGoR12.cab) SF4 and an internet phone software installation-file version 2.4.1 (Skype_{—}2.4.1.cab) SF5.

Afterward, in a step S105, the processing unit 360 compiles the first software file set SFS1 into a second software file set SFS2. In this step, the first software file set SFS1 is compiled into the second software file set SFS2 by adding files or deleting files.

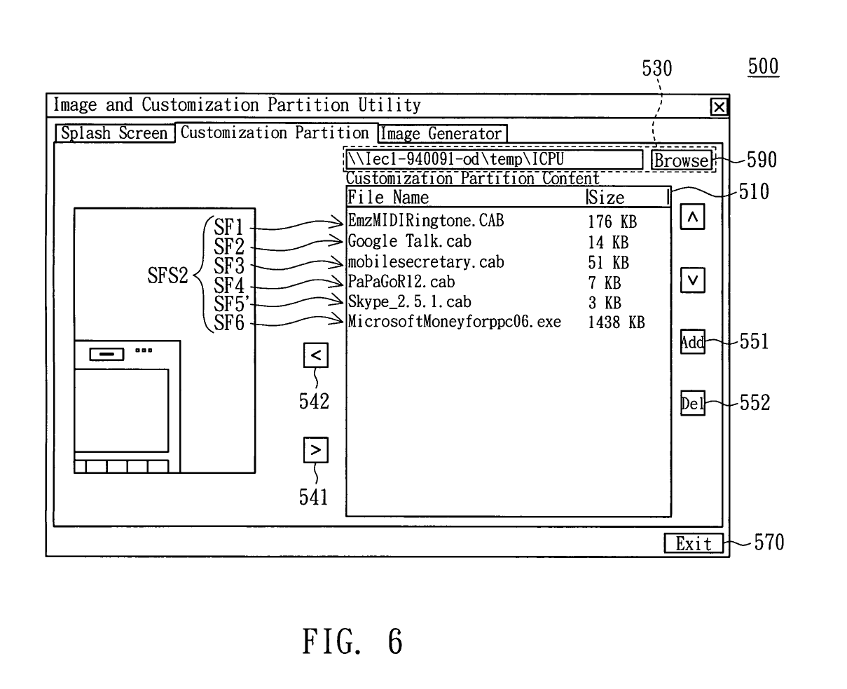

Please refer to FIG. 6. FIG. 6 illustrates the updating interface 500 of the first software file set SFS1 in FIG. 5 being compiled into the second software file set SFS2. For example, when the “delete file” button 552 of the updating interface 500 is pressed, one file is deleted. The internet phone software installation file version 2.4.1 (Skype_{—}2.4.1.cab) SF5 is deleted for example.

The second storage unit 310 stores several software files including the internet phone software installation file version 2.5.1. (Skype_{—}2.5.1.cab) SF5′ and the finance management software version 6 (MicrosoftMoneyforppc06.exe) SF6, etc. When the “add file” button 551 is pressed, one file is added into a selected file. For example, the internet phone software installation file version 2.5.1 (Skype 2.5.1 cab) SF5′ or the finance management software file version 6 (MicrosoftMoneyforppc06.exe) SF6 is added. Meanwhile, the first software file set SFS1 is compiled into the second software file set SFS2.

Afterward, in a step S106, the safety control unit 120 of the mobile device 100 removes the read-only property of the first storage unit 110.

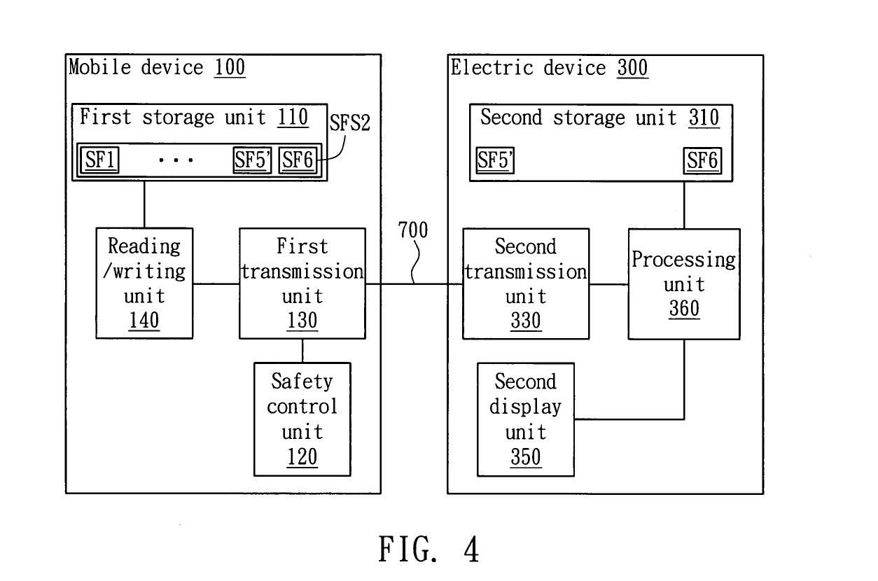

Please refer to both FIG. 4 and FIG. 6. FIG. 4 is the function block diagram of the updated mobile device 100 and the electric device 300 in FIG. 3. Later, in a step S107, when the transmission button 542 of the updating interface 500 is pressed, the mobile device 100 deletes the first software file set SFS1 first. Then, the processing unit 360 transmits the second software file set SFS2 to the mobile device 100 through the second transmission unit 330. After the first transmission unit 130 receives the second software file set SFS2, the second software file set SFS2 is transmitted to the reading/writing unit 140. Because the read-only property of the first storage unit 110 is removed in the step S106, the reading/writing unit 140 can write the second software file set SFS2 into the first storage unit 100. As a result, the first software file set SFS1 is replaced by the second software file set SFS2.

Subsequently, in a step S108, the safety control unit 120 of the mobile device 100 resets the read-only property of the first storage unit 110. The first software file set SFS1 of the mobile device 100 is replaced by the second software file set SFS2. When the exit button 570 of the updating interface 500 is pressed, the updating interface 500 is closed.

When the mobile device 100 needs to reinstall the software, the reading/writing unit 140 captures the second software file set SFS2 in the first storage unit 110 for processing installation.

When the user is not satisfied with the second software file set SFS2 stored in the mobile device 100, the user can perform the data updating method of the present embodiment again. The steps S101, S102 and S103 can be skipped so the method goes to the step S104 directly.

### Second Embodiment

The difference between a second embodiment and the first embodiment is that an auto-configuration file set (AutoConfig file set) can be updated in the present embodiment. Other parts are the same and not described redundantly. The auto-configuration file set is the procedure which is set by each system operator. To describe the data updating method of the present embodiment more clearly, a flow chart and the accompanying function block diagram are illustrated as follow.

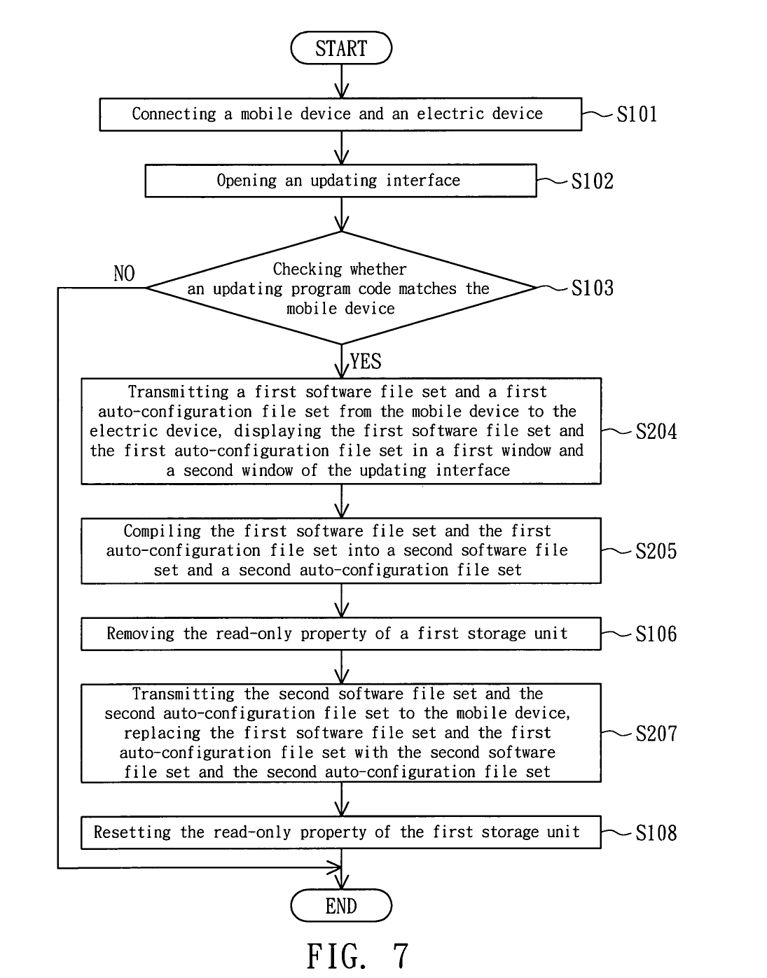

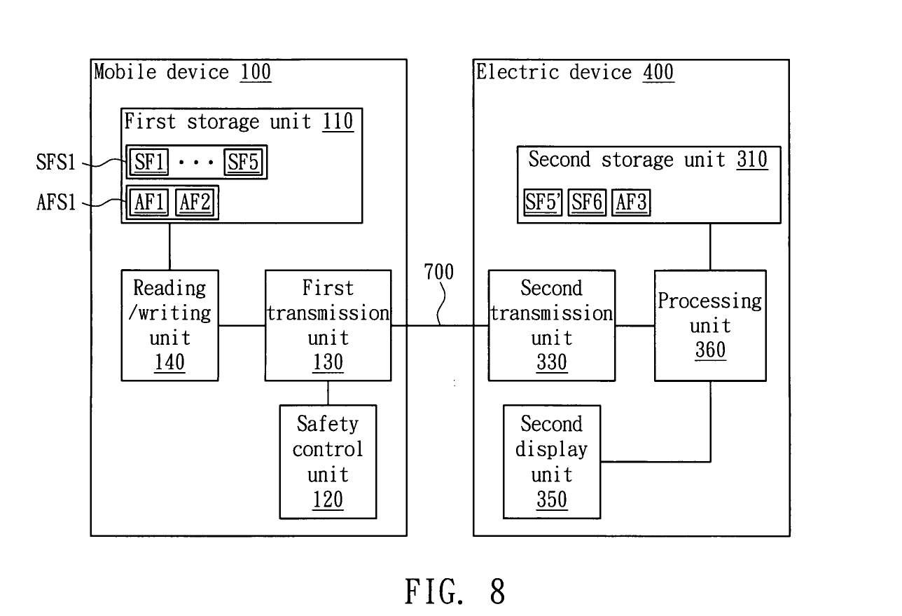

Please refer to FIG. 7 and FIG. 8 at the same time. FIG. 7 is a flow chart of the data updating method according to the second embodiment of the present invention. FIG. 8 is a function block diagram of the mobile device 100 and the electric device 400 of the second embodiment of the present invention. Although the mobile device 100 and the electric device 400 in FIG. 8 are illustrated as an example in the present embodiment, anyone who has ordinary skill in the field of the present invention can understand that the data updating method of the present invention is not limited thereto.

Although steps of the data updating method of the present embodiment in FIG. 7 are illustrated as an example, anyone who has ordinary skill in the field of the present invention can understand that the present invention is not limited thereto. Also, the order of the steps is not limited thereto.

First, in a step S101, the mobile device 100 and the electric device 400 are connected through the first transmission unit 130 and the second transmission unit 330.

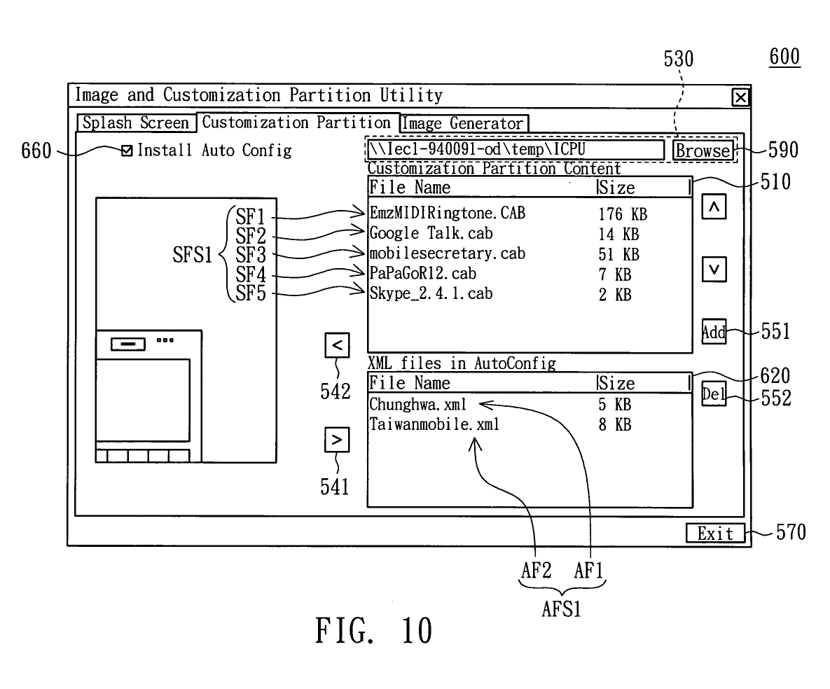

Please refer to both FIG. 7 and FIG. 10. FIG. 10 illustrates the updating interface 600 of the second embodiment of the present invention. Next, in a step S102, the updating interface 600 is launched. The updating interface 600 is shown on the second display unit 350. The updating interface 600 of the present embodiment further includes a second window 620.

Then, in a step S103, it is checked whether the updating program code and the mobile device 100 match. For example, it is checked whether the updating program code matches the operating system version, the model number or the international mobile equipment identity (IMEI) of the mobile device 100.

When the updating program code matches the mobile device 100, the method goes to a step S204. When the updating program code does not match the mobile device 100, the method ends.

In the step S204, when the download button 541 of the updating interface 600 is pressed, the reading/writing unit 140 of the mobile device 100 captures the first software file set SFS1 and the first auto-configuration file set (AutoConfig file set) AFS1 from the first storage unit 110. Also, the first software file set SFS1 and the first auto-configuration file set AFS1 are transmitted to the electric device 300 through the first transmission unit 130.

After received by the second transmission unit 330, the first software file set SFS1 and the first auto-configuration file set AFS1 are stored in the selected folder. The first software file set SFS1 and the first auto-configuration file set AFS1 are shown in the first window 510 and the second window 620 respectively. As shown in FIG. 8 and FIG. 10, the first auto-configuration file set AFS1 includes a first telecommunication system auto-configuration file (chunghwa.xml) AF1 and a second telecommunication system auto-configuration file (taiwanmobile.xml) AF2.

Afterward, in a step S205, the first software file set SFS1 and the first auto-configuration file set AFS1 are compiled by the processing unit 360 into a second software file set SFS2 and a second auto-configuration file set AFS2 from the electric device 300. In this step, the first software file set SFS1 and the first auto-configuration file set AFS1 are compiled by adding files or deleting files.

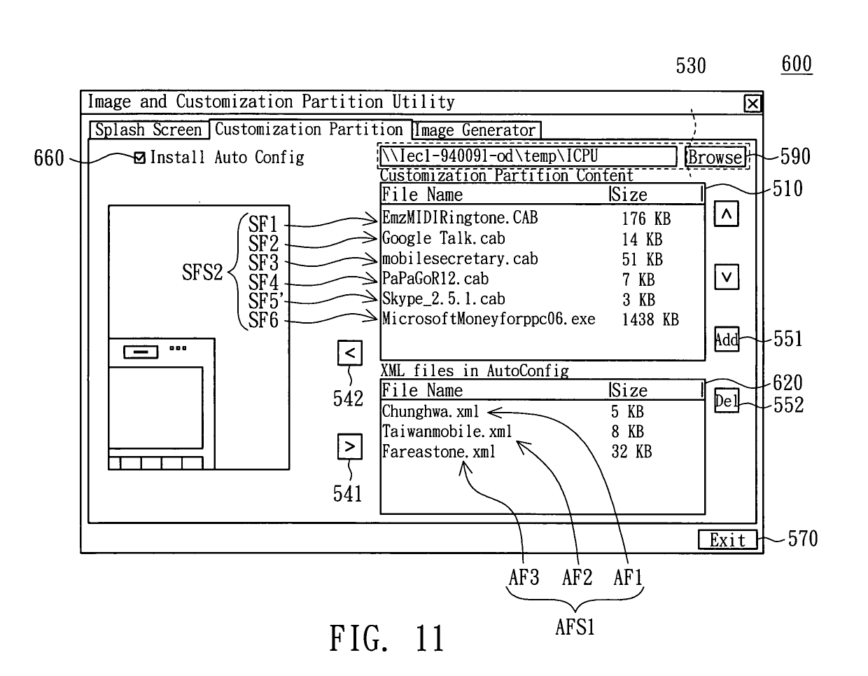

Please referring to FIG. 11, the updating interface 600 of the first software file set SFS1 and the first auto-configuration file set AFS1 being compiled into the second software file set SFS2 and the second auto-configuration file set AFS2. For example, when the “delete file” button 552 of the updating interface 600 is pressed, one file is deleted. In the present embodiment, no auto-configuration file is deleted.

The second storage unit 310 of the present embodiment further stores several auto-configuration files including a third telecommunication system auto-configuration file (fareastone.xml) AF3. When the “add file” button 551 is pressed, one file is added to a selected folder. For example, the third telecommunication system auto-configuration file (fareastone.xml) AF3 is added. Meanwhile, the first auto-configuration file set AFS1 is complied into a second auto-configuration file set AFS2.

Later, in a step S106, the safety control unit 120 of the mobile device 100 removes the read-only property of the first storage unit 110.

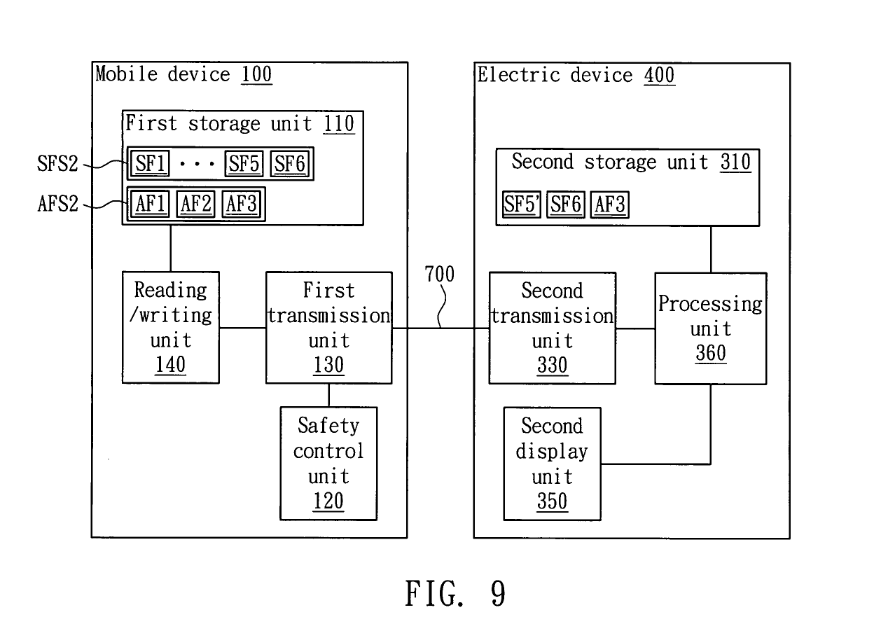

Please refer to both FIG. 9 and FIG. 11. FIG. 9 is a function block diagram of the mobile device 100 and the electric device 400 in FIG. 8 after the data is updated. Subsequently, in a step S207, when the transmission button 542 of the updating interface 600 is pressed, the mobile device 100 deletes the first software file set SFS1 and the first auto-configuration file set AFS1. The processing unit 360 transmits the second software file set SFS2 and the second auto-installation file AFS2 to the mobile device 100 through the second transmission unit 330. After the first transmission unit 130 receives the second software file set SFS2 and the second auto-configuration file set AFS2, the second software file set SFS2 and the second auto-configuration file set AFS2 are transmitted to the reading/writing unit 140. Because the read-only property of the first storage unit 110 is removed in the step S106, the reading/writing unit 140 can write the second software file set SFS2 and the second auto-configuration file set AFS2 into the first storage unit 110. As a result, the first software file set SFS1 and the first auto-configuration file set AFS1 are replaced by the second software file set SFS2 and the second auto-configuration file set AFS2.

Moreover, in a step 207, the updating interface 600 further includes an installation button. When the installation button is selected, the second auto-configuration file set AFS2 is transmitted to the mobile device 100. When the installation button is not selected, the second auto-configuration file set AFS2 is not transmitted to the mobile device 100.

Thereon, in a step S108, the safety control unit 120 of the mobile device 100 resets the read-only property of the first storage unit 110. The first software file set SFS1 and the first auto-configuration file set AFS1 are replaced by the second software file set SFS2 and the second auto-configuration file setAFS2 respectively. When the exit button 570 of the updating interface 600 is pressed, the updating interface 600 is closed.

When the user want to reinstall the software, the reading/writing unit 140 captures the second software installation file SFS2 and the second auto-configuration file set AFS2 in the first storage unit 110 and processes the installation.

### Third Embodiment

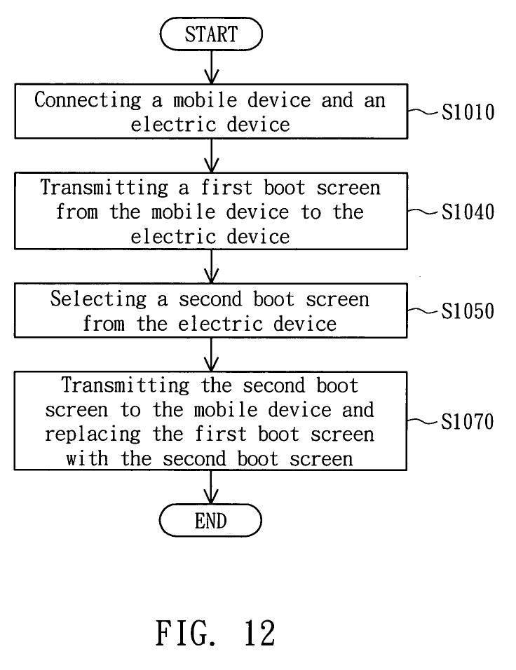

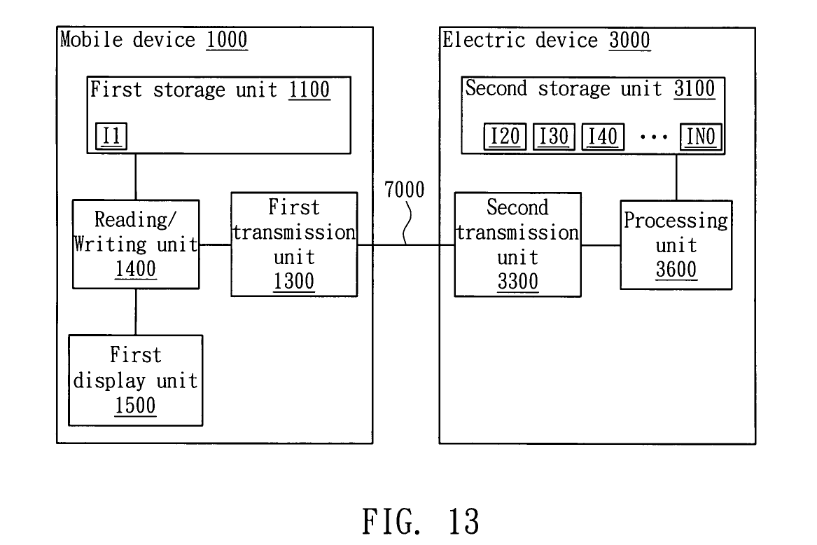

FIG. 12 is a flow chart of the data updating method according to a third embodiment of the present invention. Please refer to FIG. 12. The data updating method is for updating a first boot screen I10 (the mobile device 1000 and the first boot screen I10 are illustrated in FIG. 13) of the mobile device 1000. The boot screen I10 is a picture or an animation displayed when a user boots an operating system for showing a company logo, a welcome slogan, time and date, some pictures or words. The data updating method includes at least a step S1050, a step S1040 and a step S1070. An accompanying function block diagram is used for describing the data updating method of the present embodiment more clearly.

Please refer to both FIG. 12 and FIG. 13. FIG. 13 is a function block diagram of the mobile device 1000 and the electric device 3000 according to the third embodiment of the present invention. Although the mobile device 1000 and the electric device 3000 are used as examples in the data updating method of the present embodiment, anyone who has ordinary skill in the field of the invention can understand that the data updating method of the invention is not limited thereto.

For example, the mobile device 1000 is a mobile phone, a personal digital assistant (PDA), or a global positioning system receiver (GPS receiver). The electric device 3000 is a desktop computer or a notebook for example. The mobile device 1000 includes a first storage unit 1100, a reading/writing unit 1400, a first transmission unit 1300 and a first display unit 1500. The electric device 3000 includes a second storage unit 3100, a processing unit 3600 and a second transmission unit 3300. The electric device 3000 is for storing an updating program code for performing the data updating method of the present embodiment.

First, in a step S1010, the mobile device 1000 and the electric device 3000 are connected through the first transmission unit 1300 and the second transmission unit 3300. The mobile device 1000 and the electric device 3000 communicate through the common communication protocol. For example, the common communication protocol is a universal series bus (USB), a mini universal serial bus (mini bus) or a high-speed serial bus (IEEE 1394). In other words, the first transmission unit 1300 and the second transmission unit 3300 are USB ports, mini USB ports or IEEE 1394 ports correspondingly. No matter which ports the first transmission unit 1300 and the second transmission unit 3300 are, the mobile device 1000 and the electric device 3000 can be connected through a proper transmission line 700.

Then, in a step S1040, the first boot screen I10 is captured by the reading/writing unit 1400 of the mobile device 1000 from the first storage unit 1100 and then transmitted to the electric device 3000 through the first transmission unit 1300.

Next, in a step S1050, the processing unit 3600 selects a second boot screen I20 from the second storage unit 3100 of the electric device 3000. The processing unit 3600 is a central processing unit (CPU) for example. The second storage unit 3100 is a hard drive for example. The second boot screen I20 can be all types of pictures or patterns, or even animations or videos. In addition to storing the second boot screen I20, the second storage unit 3100 can store several sets of boot screens, such as a third boot screen I30, a fourth boot screen I40, . . . or an nth boot screen IN0, for providing various choices.

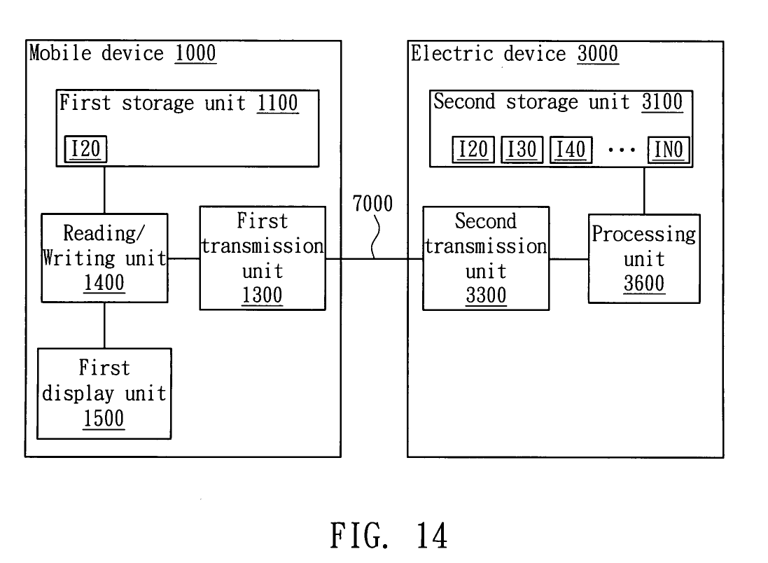

Please refer to FIG. 14 at the same time. FIG. 14 is a function block diagram of the mobile device 1000 and the electric device 3000 in FIG. 13 after the data is updated. Afterwards, in a step S1070, the processing unit 3600 transmits the second boot screen I20 to the mobile device 1000 through the second transmission unit 3300. After the first transmission unit 1300 receives the second boot screen I20, the second boot screen I20 is transmitted to the reading/writing unit 1400. The reading/writing unit 1400 writes the second boot screen I20 into the first storage unit 1000 for replacing the first boot screen I10 with the second boot screen I20.

Later, when the mobile device 100 is booted, the second boot screen I20 stored in the first storage unit 1100 is captured by the reading/writing unit 1400 and then displayed in the first display unit 1500.

As stated above, through the data updating method and the electric device 3000 using the same with the updating program code, the mobile device 1000 does not need to be sent back to the original manufacturer. It is easy to update the boot screen of the mobile device 1000 through the electric device 3000. Also, the electric device 3000 of the present embodiment can store several sets of boot screens for providing various choices for the user.

### Fourth Embodiment

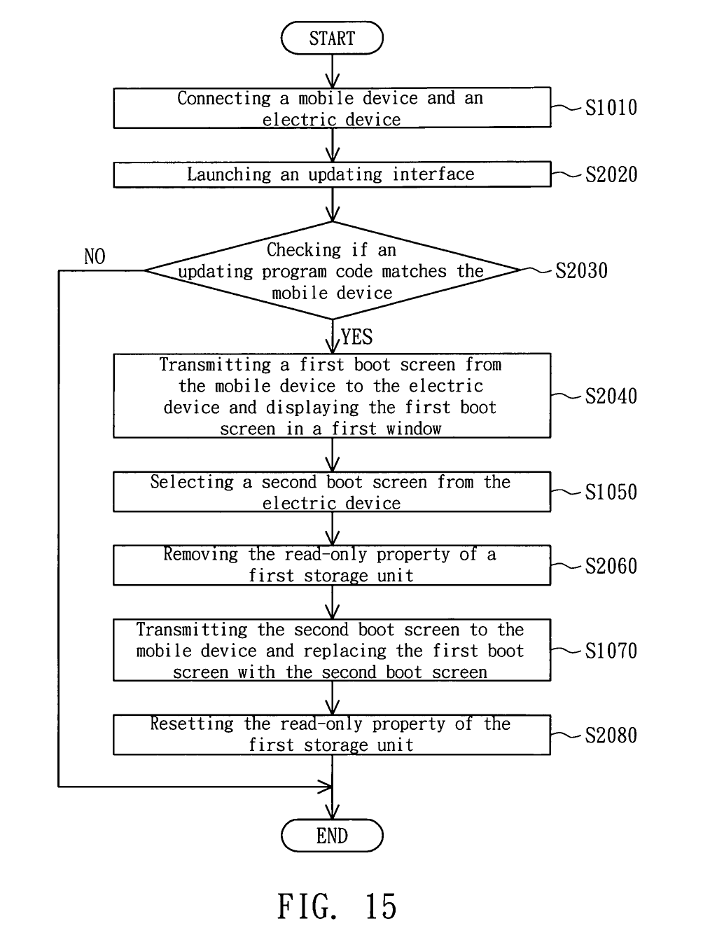

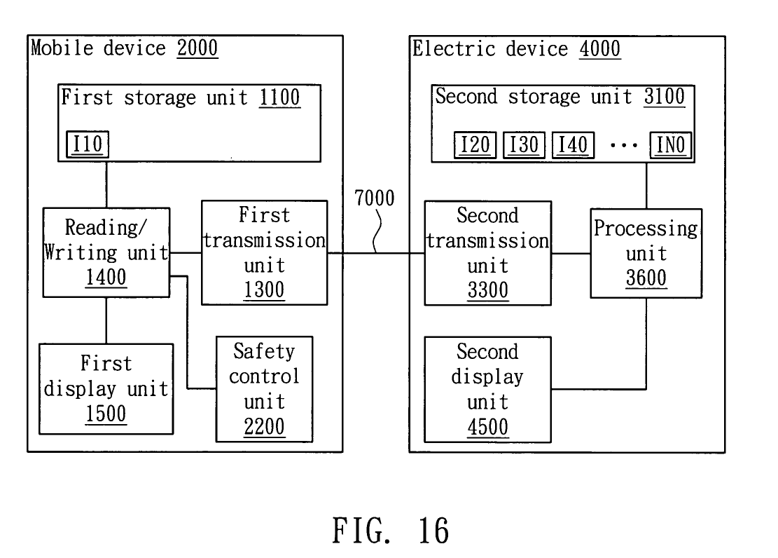

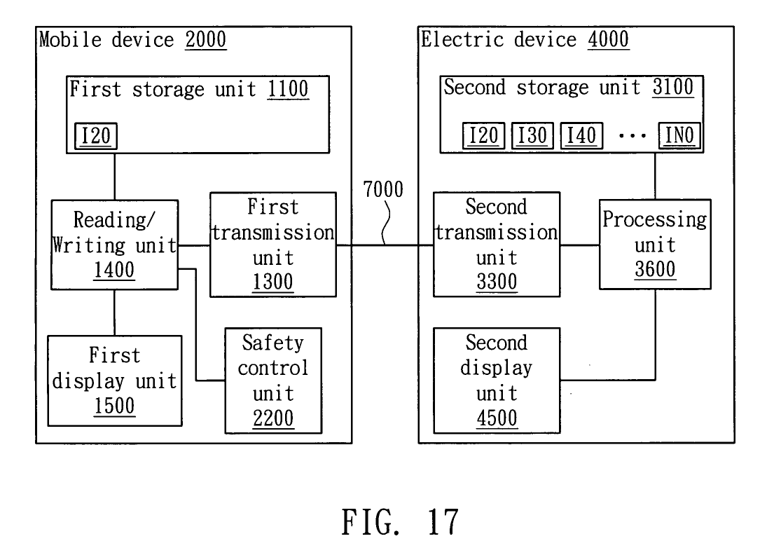

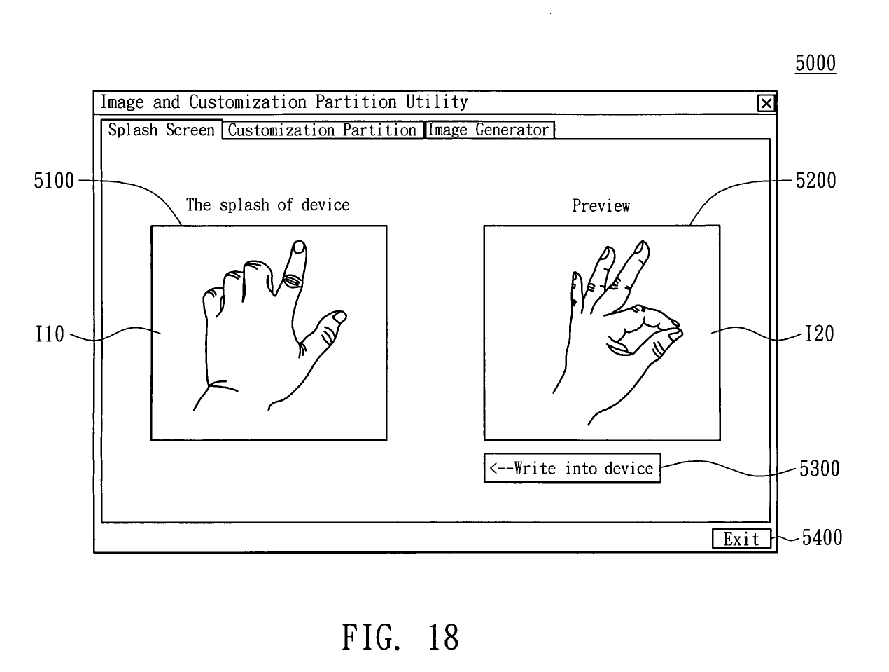

The difference between the data updating method and the electric device 4000 using the same with the updating program code of the present embodiment and those of the third embodiment is that the electric device 4000 further includes an updating interface 5000 (please refer to FIG. 18). Also, the mobile device 2000 further includes a safety control unit 2200. And the data updating method of the present embodiment includes corresponding data updating steps. Other parts are the same and not described repeatedly. (The electric device 4000, the mobile device 2000 and the safety control unit 2200 are shown in FIG. 16 and FIG. 17. The updating interface 5000 is shown in FIG. 18.) FIG. 15 is a flow chart of the data updating method according to the fourth embodiment of the present invention. Please refer to FIG. 15. The data updating method is for updating the first boot screen I10 of the mobile device 2000 (the first boot screen I10 is shown in FIG. 16). An accompany function block diagram is used for illustrating the data updating method of the present embodiment more clearly.

Please refer to FIG. 15 and FIG. 16 at the same time. FIG. 16 is a function block diagram of the mobile device 2000 and the electric device 3000 according to the fourth embodiment of the present invention. Although the mobile device 2000 and the electric device 4000 are illustrated as examples in the present embodiment, anyone who has ordinary skill in the field of the invention can understand that the data updating method of the present invention is not limited thereto.

Furthermore, although the data updating method of the present embodiment includes steps in FIG. 15 as an example, anyone who has ordinary skill in the field of the present invention can understand that the data updating method of the invention is not limited thereto. Also, the order of the steps in the data updating method of the present invention is not limited to.

As shown in FIG. 16, the mobile device 2000 of the present embodiment further includes the safety control unit 2200. The electric device 4000 of the present embodiment further includes a second display unit 4500 for displaying the updating interface 5000. The second display unit 4500 is a liquid crystal display (LCD) or a cathode ray tube display (CRT display) for example. Also, the electric device 4000 further stores an updating program code for performing the data updating method of the present embodiment.

First, in a step S1010, the mobile device 2000 and the electric device 4000 are connected through the first transmission unit 1300 and the second transmission unit 3300.

Please referring to FIG. 18, the updating interface 5000 according to the fourth embodiment of the present invention is illustrated in FIG. 18. Next, in a step S2020, the updating interface 5000 is launched. The updating interface 5000 is displayed in the second display unit 4500. The user can obtain all kinds of information and operate through the updating interface 5000. The updating interface 5000 includes a first window 5100, a second window 5200, a transmission button 5300 and an exit button 5400.

Then, in a step S2030, it is checked if the updating program code and the mobile device 2000 match. In the present embodiment, the safety control unit 2200 of the mobile device 2000 checks if the updating program code matches the mobile device 2000. For example, the safety control unit 2200 checks the version of the operation system, the model number or the serial number of the mobile device 1000. Moreover, the updating program code and the mobile device 2000 can also be checked through the processing unit 3600 of the electric device 4000 in the step S2030.

When the updating program code matches the mobile device 2000, the method goes to a step S2040. When the updating program code does not match the mobile device 2000, the data updating method ends.

In the step S2040, the first boot screen I10 is captured from the first storage unit 1100 by the reading/writing unit 1400 of the mobile device 2000 and then transmitted to the electric device 4000 through the first transmission unit 1300. After the second transmission unit 3300 receives the first boot screen I10, the first boot screen I10 is displayed in the first window 5100, as shown in FIG. 18.

Then, in a step S1050, the processing unit 3600 selects the second boot screen I200 from the second storage unit 3100 of the electric device 4000. The processing unit 3600 is a central processing unit (CPU) for example. The second storage unit 3100 is a hard drive for example. The second boot screen I20 can be all types of pictures or patterns, or even animations or videos. The second storage unit 3100 can store several sets of boot screens, such as the third boot screen I30, the fourth boot screen I40, . . . or the nth boot screen IN0, for providing various choices.

In this step, the selected second boot screen I20 is displayed in the second window 5200 of the updating interface 5000. The user can preview the second boot screen I20 through the second window 5200 and decide whether he/she wants it or not. When the user does not want to choose the second boot screen I20, the user can choose again immediately. The user does not need to wait until the second boot screen I20 is transmitted to the mobile device 2000 and then realizes the second boot screen I20 is not suitable for him/her. As a result, the data updating time can be reduced significantly.

Furthermore, in this step, because the size of the second boot screen I20 is different, the second boot screen may not fit the screen size of the mobile device 2000. Therefore, the processing unit 3600 preferably adjusts the size of the second boot screen I20 automatically for fitting the screen size of the mobile device 2000. For example, the size of the second boot screen I20 is adjusted by cutting, stretching, centering or compressing.

Later, in a step S2060, the safety control unit 2200 of the mobile device 2000 removes the read-only property of the first storage unit 1100.

FIG, 17 is a function block diagram of the mobile device 2000 and the electric device 4000 in FIG. 16 after the data is updated. Please refer to FIG. 17. Subsequently, in a step S1070, when the transmission button 5300 of the updating interface 5000 is pressed, the processing unit 3600 transmits the second boot screen I20 to the mobile device 2000 through the second transmission unit 3300. After the first transmission unit 1300 receives the second boot screen I20, the second boot screen I20 is transmitted to the reading/writing unit 1400. Because the read-only property of the first storage unit 1100 is removed in the step S2060, the reading/writing unit 1400 can write the second boot screen I20 into the first storage unit 1100, for replacing the first boot screen I10 with the second boot screen I20.

Afterward, in a step S2080, the safety control unit 2200 of the mobile device 2000 resets the read-only property of the first storage unit 1100. The first boot screen I10 of the mobile device 2000 is already replaced by the second boot screen I20. When the user presses the exit button 5400 through a mouse, the updating interface 5000 is closed.

When the mobile device 200 boots, the second boot screen I20 is captured from the first storage unit 110 by the reading/writing unit 140 and then displayed in the first display unit 150.

When the user does not satisfy with the second boot screen I20 displayed by the mobile device 2000, the data updating method of the present embodiment can be performed again. The steps S1010, S2020 and S3030 can be skipped, and the method goes to the step S2040 directly.

In the data updating method and the electric device using the same of the above embodiments, the software file set is compiled and updated in the electric device and then transmitted to the mobile device. Therefore, the data updating method and the electric device using the same have following advantages.

First, the electric device can store different kinds of software files and auto-configuration files for the user to select. The user has more choices.

Second, before the file is transmitted to the mobile device, the user can browse the file through the updating interface. After the user selects the file to be installed, the file is transmitted to the mobile device. It is very convenient, and a lot of updating time can be saved.

Third, the updating interface is a graphic user interface (GUI). The user can select the graphic button by using a mouse to perform the data updating method of the present invention conveniently.

Fourth, the updating program code of the above embodiments can be burned into a disk or stored in internet space, so that the user can install or download to the personal computer conveniently.

Fifth, in the process of the data updating method, the mobile device checks the updating interface through the safety control unit. The safety control unit sets or removes the read-only property of the first storage unit. As a result, the entire data updating process is safe.

Sixth, the user does not need to send the mobile device back to the original manufacturer to perform the updating process, which is quite convenient.

Seventh, the electric device can store several different second boot screens for providing the user with various choices.

Eighth, the size of the second boot screen can be adjusted for fitting the screen size of the mobile device. Therefore, the variety of the second boot screen I20 is increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data updating method for updating a first software file set of a mobile device, the mobile device adapted to be electrically connected to an electric device with a updating program code, the updating program code for performing the data updating method, the method comprising:
(d) transmitting the first software file set to the electric device from the mobile device and displaying the first software file set in a first window;
(e) compiling the first software file set into a second software file set; and
(g) transmitting the second software file set to the mobile device and replacing the first software file set with the second software file set.

2. The method according to claim 1, wherein the first software file set is complied into the second software file set by adding files or deleting files in the step (e).

3. The method according to claim 1 further for updating a first auto-configuration file set (AutoConfig file set) of the mobile device, the method further comprising:
transmitting the first auto-configuration file set to the electric device from the mobile device and displaying the first auto-configuration file set in a second window in the step (d);
compiling the first auto-configuration file set into a second auto-configuration file set in the step (e);
transmitting the second auto-configuration file set to the mobile device and replacing the first auto-configuration file set with the second auto-configuration file set in the step (g).

4. The method according to claim 3, wherein the first auto-configuration file set is complied into the second auto-configuration file set by adding files or deleting files in the step (e).

5. The method according to claim 1 further comprising:
(c) checking whether the updating program code matches the mobile device.

6. The method according to claim 1, wherein the mobile device and the electric device communicate through a common communication protocol.

7. The method according to claim 6, wherein the common communication protocol is a universal serial bus (USB), a mini universal serial bus (mini USB) or a high-speed serial bus (IEEE 1394).

8. The method according to claim 1, wherein the first software file set is stored in a first storage unit, before the step (g) the method further comprising:
(f) removing the read-only property of the first storage unit.

9. The method according to claim 8, wherein after the step (g) the method further comprises:
(h) resetting the read-only property of the first storage unit.

10. The method according to claim 1 further comprising:
(i) transmitting a first boot screen to the electric device from the mobile device;
(j) selecting a second boot screen from the electric device; and
(k) transmitting the second boot screen to the mobile device and replacing the first boot screen with the second boot screen.

11. The data updating method according to claim 10, wherein the electric device comprises a second display unit for displaying a first window, in the step (i) the first boot screen being displayed in the first window.

12. The data updating method according to claim 11, wherein the second display unit is for further displaying a second window, in the step (j) the second boot screen being displayed in the second window.

13. The data updating method according to claim 12, wherein the step (j) further comprises adjusting the size of the second boot screen for fitting the screen size of the mobile device.

14. The data updating method according to claim 10, wherein the first boot screen is stored in a first storage unit; wherein before the step (l) the dating updating method further comprising:
(k) removing the read-only property of the first storage unit.

15. The data updating method according to claim 14 further comprising:
(m) setting the read-only property of the first storage unit after the step (l).

16. An electric device storing an updating program code for performing a data updating method, the method for updating a first software file set of a mobile device, the mobile device adapted to be electrically connected to the electric device, the method at least comprising:
(d) transmitting the first software file set to the electric device from the mobile device and displaying the first software file set in a first window;
(e) compiling the first software file set into a second software file set; and
(g) transmitting the second software file set to the mobile device and replacing the first software file set with the second software file set.

17. The electric device according to claim 16, wherein the first software file set is compiled into the second software file set by adding files or deleting files in the step (e).

18. The electric device according to claim 16, wherein the data updating method is further for updating a first auto-configuration file set (AutoConfig file set) of the mobile device, the method further comprising:
transmitting the first auto-configuration file set to the electric device from the mobile device and displaying the first auto-configuration file set in a second window in the step (d);
compiling the first auto-configuration file set into a second auto-configuration file set in the step (e); and
transmitting the second auto-configuration file set to the mobile device and replacing the first auto-configuration file set with the second auto-configuration file set in the step (g).

19. The electric device according to claim 18, wherein the first auto-configuration file set is compiled into the second auto-configuration file set by adding files or deleting files.

20. An electric device with an updating program code for updating a first software file set of a mobile device, the electric device at least comprising:
a second transmission unit for connecting the mobile device and transmitting the first software file set to the electric device;
a second display unit for displaying the first software file set in a first window; and
a processing unit compiling the first software file set into a second software file set, transmitting the second software file set to the mobile device through the second transmission unit, replacing the first software file set with the second software file set.

21. The electric device according to claim 20, wherein the processing unit compiles the first software file set into the second software file set by adding files or deleting files.

22. The electric device according to claim 20, wherein the electric device is further for updating a first auto-installation file set (AutoConfig file set) of the mobile device;
the second transmission unit further for transmitting the first auto-configuration file set to the electric device;
the second display unit further for displaying the first auto-configuration file set in a second window;
the processing unit further compiling the first auto-configuration file set into a second auto-configuration file set, transmitting the second auto-configuration file set to the mobile device through the second transmission unit, replacing the first auto-configuration file set with the second auto-configuration file set.

23. The electric device according to claim 22, wherein the processing unit compiles the first auto-configuration file set into the second auto-configuration file set by adding files or deleting files.

24. The electric device according to claim 20, wherein the mobile device comprises a safety control unit and a first transmission unit connected with the second transmission unit, the safety control unit for checking whether the updating program code matches the mobile device.

25. The electric device according to claim 20, wherein the mobile device and the electric device communicate through a common communication protocol.

26. The electric device according to claim 25, wherein the common communication protocol is a universal serial bus (USB), a mini universal serial bus (mini USB) or a high-speed serial bus (IEEE 1394).

27. The electric device according to claim 20, wherein the mobile device further comprises a first storage unit for storing the first software file set; the safety control unit removing the read-only property of the first storage unit before the processing unit transmits the second software file set to the mobile device.

28. The electric device according to claim 21, wherein the safety control unit resets the read-only property of the first storage unit after the processing unit replaces the first software file set and the first auto-configuration file set with the second software file set and the second auto-configuration file set.

29. The electric device according to claim 20 further comprising:
a second storage unit for storing at least a second boot screen;
wherein the second display unit is electrically connected with the second storage unit, the second display unit for selecting the second boot screen, the processing unit electrically connected with the second transmission unit and the second storage unit, the processing unit transmitting the second boot screen to the mobile device through the second transmission unit and replacing the first boot screen with the second boot screen.

30. The electric device according to claim 29, wherein the mobile device comprises a safety control unit and a first transmission unit, the first transmission unit connected with the second transmission unit, the safety control unit for checking if the updating program code matches the mobile device.

31. The electric device according to claim 30, wherein the second display unit comprises a first window, the first boot screen being transmitted to the electric device by the processing unit through the first transmission unit and then displayed in the first window.

32. The electric device according to claim 31, wherein the second display unit further comprises a second window, the second boot screen being displayed in the second window.

33. The electric device according to claim 32, wherein the processing unit further adjusts the size of the second boot screen for fitting the screen size of the mobile device.

34. The electric device according to claim 29, wherein the mobile device further comprises a first storage unit for storing the first boot screen; wherein the safety control unit removes the read-only property of the first storage unit before the processing unit transmits the second boot screen to the mobile device.

35. The electric device according to claim 34, wherein the safety control unit further sets the read-only property of the first storage unit after the processing unit replaces the first boot screen with the second boot screen.
